(19) United States
(12) Patent Application Publication
(10) Pub. No.: US 2011/0179498 A1
(43) Pub. Date: Jul. 21, 2011

(54) SYSTEM FOR MANAGING ACCESS RIGHTS TO AN OBJECT OF AN OBJECT ORIENTED PROGRAMMING LANGUAGE

(75) Inventor: Ernst Haselsteiner, Graz (AT)

(73) Assignee: NXP B.V., Eindhoven (NL)

(21) Appl. No.: 13/120,849

(22) PCT Filed: Sep. 25, 2009
(86) PCT No.: PCT/IB2009/054197

§ 371 Date: Mar. 24, 2011

(30) Foreign Application Priority Data
Sep. 25, 2008 (EP) 08105436.3
Sep. 25, 2009 (IB) PCT/IB2009/054197

(51) Int. Cl. G06F 21/00

(52) U.S. Cl. 726/27

(57) ABSTRACT

A device (100) for managing access rights to an object of an object oriented programming language, wherein the device comprises a processing unit (101) and a memory management unit (102). The processing unit (101) is adapted for determining information in [symbol] dicative of the access rights to the object and for storing the determined information in the memory management unit (102).

### FIELD OF THE INVENTION

The invention relates to a device for managing access rights to an object of an object oriented programming language.

Beyond this, the invention relates to a method of managing access rights to an object of an object oriented programming language.

Moreover, the invention relates to a program element.

Furthermore, the invention relates to a computer-readable medium.

### BACKGROUND OF THE INVENTION

The importance of automatic identification systems increases particularly in the service sector, in the field of logistics, in the field of commerce and in the field of industrial production. Further applications of identification systems are related to the identification of persons and animals.

In particular contactless identification systems like transponder systems (for instance using an RFID tag) are suitable for a wireless transmission of data in a fast manner and without cable connections that may be disturbing. Such systems use the emission and reflection/absorption of electromagnetic waves, particularly in the high frequency domain.

For a normal contactless smart card transaction or contact based system transaction, the terminal starts to send a message to request all present cards to provide a response. During the initialization phase all cards provide an identification code that allows the terminal to distinguish the cards and address them individually. Such transponder system conventionally is based on simple algorithms and software routines.

In another technical field, namely the field of computing systems like a PC or server, such high performance computing platforms may be controlled by programs, as for example Java programs, carried out by a processor. In the Java Programming Language the Java programs or applets that is programs that are embedded in other applications, typically in a Web page displayed in a Web browser, have no direct access to the main memory of the platform on which they are executed. This is in contrast to programming languages like C or C++, which still allow programs to actually allocate pieces of main memory and directly access these pieces of memory. In Java, a program may only allocate memory by creating new objects, like for instance arrays. However, it is impossible to determine the address of the memory, which is used to hold these objects. The only way to access these objects is via calls to the Java application programming interface (API). This is a benefit from a security point of view, as the program can only access memory that has the correct settings to be accessed by this program. The access control manager in Java takes care about whether a certain Java program or applet is allowed to access a certain piece of information of an object. Due to the fully object-oriented approach of Java, nearly everything is an object and accessing an object is one of the most frequent things a Java program does. As a consequence, the Java environment, or more precisely the access control manager, needs to do many checks whether certain accesses are to be granted/allowed or to be rejected/not allowed. In the area of Java on high performance computing platforms like PCs, this is (such checks are) not a real issue.

US 2002/0166052 A1 discloses a system for caching in connection with authorization in a computer system. An authorization handle is supported for each access policy determination that is likely to be repeated. In particular, an authorization handle may be assigned to access check results associated with the same discretionary access control list and the same client context. This likelihood may be determined based upon pre-set criteria for the application or service, based on usage history and the like. Once an access policy determination is assigned an authorization handle, the static maximum allowed access is cached for that policy determination. From access check to access check, the set of permissions desired by the client may change, and dynamic factors that might affect the overall privilege grant may also change; however, generally there is still a set of policies that is unaffected by the changes and common across access requests. The cached static maximum allowed access data is thus used to provide efficient operations for the evaluation of common policy sets. In systems having access policy evaluations that are repeated, authorization policy evaluations may be more efficient, computer resources may be free for other tasks, and performance improvements may be observed.

U.S. Pat. No. 7,260,831 B1 discloses a system concerning a resource access decision facility, preferably a Corba RAD. Resource access decisions obtained from RAD are placed in a cache. An application can retrieve access decisions directly from the cache rather than requesting the decisions from RAD. If an access decision is not available in the cache, the access decision is requested from RAD.

### OBJECT AND SUMMARY OF THE INVENTION

It is an object of the invention to provide a system for managing access rights to an object of an object oriented programming language saving time and energy resources.

In order to achieve the object defined above, a device for managing access rights to an object of an object oriented programming language, a method of managing access rights to an object of an object oriented programming language, a program element and a computer-readable medium according to the independent claims are provided.

According to an exemplary embodiment of the invention, a device for managing access rights to an object of an object oriented programming language is provided wherein the device comprises a processing unit (which may have processing capabilities) and a memory management unit (MMU). The processing unit may be adapted for determining information indicative of the access rights to the object and for storing the determined information in the memory management unit.

According to another exemplary embodiment of the invention, a method of managing access rights to an object of an object oriented programming language is provided. The method may comprise determining information indicative of the access rights to the object and storing the determined information in a management memory unit.

According to still another exemplary embodiment of the invention, a program element (for instance a software routine, in source code or in executable code) is provided, which, when being executed by a processor, is adapted to control or carry out an access rights managing method having the above mentioned features.

According to yet another exemplary embodiment of the invention, a computer-readable medium (for instance a semiconductor memory, a CD, a DVD, a USB stick, a floppy disk or a harddisk) is provided, in which a computer program is stored which, when being executed by a processor, is adapted to control or carry out an access rights managing method having the above mentioned features.

Managing of access rights, which may be performed according to embodiments, of the invention can be realized by a computer program that is by software, or by using one or more special electronic optimization circuits, that is in hardware, or in hybrid form, that is by means of software components and hardware components.

The term “object oriented programming language” may denote a programming language that allows or encourages, to some degree, object oriented programming techniques such as encapsulation, inheritance, modularity, and polymorphism. Object oriented programming (OOP) may denote a class of programming languages and techniques based on the concept of an “object”. Examples of object oriented programming languages are Java, Simula or C++.

The term “object” may denote, in object oriented programming languages, a defined object. Such objects may be defined in so termed classes, which define the abstract characteristics of an object, including its access rights and behaviors. An object may be a data structure encapsulated with a set of routines which operate on the data.

The term “processing unit” may denote a unit, which may be used for executing a sequence of stored instructions, also called program. Further, the processing unit may determine the information that is indicative of the access rights to the object and for storing the determined information in the memory management unit. The processing unit may be a single unit or part of a unit, for instance it may be part of the memory management unit.

The term “access rights” may denote the characteristics of objects concerning which user or part of a program may get access to the object. An access right may be granted without limitations allowing an entity to access the object, may be granted with limitations allowing an entity to access the object only within boundary conditions, or may be denied preventing an entity to access the object.

The term “memory management unit” (MMU) may denote a computer hardware component responsible for handling accesses to memory requested by the processing unit. Its functions may include translation of virtual addresses to physical addresses, memory protection or cache control.

In an embodiment, a high speed of management of access rights may be obtained by using a conventional memory management unit, which may be for example already available on most of the more sophisticated Smart Card chips. Therefore, time and energy may be saved because the checks performed by the memory management unit may be much more energy efficient than checks performed by a general purpose CPU of the Smart Card chip. The processing unit and the memory management unit may also be realized in one single unit (for instance as a single electronic chip) or the processing unit may be part of the memory management unit, or vice versa. The processing unit and the memory management unit may be monolithically integrated in an integrated circuit (IC). Hence, embodiments of the invention may allow saving time and energy during performance of access control verifications even when being used on space restricted platforms.

Conventional memory units are used at a much higher abstraction layer than proposed by embodiments of the invention. They have been mainly designed to protect the operating system from applications and to protect application data of one application from other applications. In this embodiment of the present invention, the memory management unit may be used within one application or applet in the form of an access control decision cache. Therefore, the memory management unit may store information indicative of the access rights to an object, wherein the access rights may be determined by a processing unit.

In the following, further exemplary embodiments of the device will be explained. However, these embodiments also apply to the method, to the program element and to the computer-readable medium.

The processing unit may be adapted for reusing the information stored in the memory management unit. Determining and storing information indicative for access rights to an object may take some time and may involve computational burden, so preferably this determining and storing is not done automatically for every object. When an access to an object is requested, it may be first checked if the access to the object is granted in general. Further it may be checked if the object is for example an array, if the requested object refers to a valid index value of the array. However, if the check is okay, a window in the memory management unit may be set up, which allows access to the memory. Preferably, no windows are set up per default. Therefore, for the first access to an object, there may be an overhead to set up the memory management unit window.

However, for every following access to this object, the memory management unit may be used to give the right decision that is if access should be allowed, immediately by solely taking information regarding access rights as stored in the MMU. Therefore, the checks preferably need to be done only once which may allow saving any kind of loop or repeating access of the same object. Hence, such a system is particularly appropriate for processors with simple processing capability.

The processing unit may be adapted—upon determining that an access right to the object is already stored in the memory management unit—for retrieving corresponding data from the memory management unit. Therefore, the processing unit may get first information if an access right has already been stored. If this is the case and the access has to be allowed, the processing unit may get access without any further processing. If the memory management unit does not contain any access information, it may be determined if access should be granted or not. If access should be granted, this information may be stored in the memory management unit. If access should not be granted, an error may occur, which means that an exception may be output or thrown and the program may be ended. This may be the case for instance if an object of a non-public class should be accessed which is in another package.

The processing unit may be adapted for determining whether a user is authorized to access the object before allowing the access to the object. The term “user” may denote any entity coupled for communication with the processing unit such as a human operator or a program part. An authorization may be determined if the user and the object are parts of different packages or sub-part of a program, wherein an access may only be granted for users and objects of the same sub-part.

The object oriented programming language may be Java. Java derives much of its syntax from C and C++ but has a simpler object model and fewer low-level facilities. Java applications are typically compiled to bytecode that can run on any Java virtual machine (JVM) regardless of computer architecture. One characteristic especially of Java as object oriented programming language is the platform independence, which means that programs written in the Java language must run similarly on any supported hardware/operating-system platform. One should be able to write a program once, compile it once, and run it anywhere.

The object may be a software element. This may be for example a class in Java. Such a software element may be in source code or may be a binary code obtained after compilation. A software element may include instructions executable by a processor and may hence include machine readable code.

The device may be adapted for wireless communication with a communication partner device, particularly a reading device, for reading data from the device. For this purpose, the device and the reading device may comprise corresponding transmission elements. For instance, the device may comprise an antenna, wherein the reading device may comprise a corresponding receiving antenna. However, the inventive device is not limited to wireless or contactless data transmission, but in principle also applies to wired communication.

The device may be adapted for a wired communication with a communication partner device, particularly a reading device, for reading data from the device. Such a device may be for example a money card which is used in an automate (machine) for paying. The device may be read via a physical connection.

The device may be a transponder adapted for wireless communication. The transponder may preferably be one of the group consisting of a smart card, a contactless chip card and a RFID tag. The term “transponder” may particularly denote an RFID tag or a (for instance contactless) smart card. More generally, a transponder may be a device (for instance comprising a chip) which may automatically transmit certain (for example encoded) data when activated by a special signal from an interrogator. Such a transponder may be adapted for communication with a communication partner device such as a reader device. The term “reader device” may denote a base station adapted for sending an electromagnetic radiation beam for reading out a transponder and detecting a back reflected signal. Such a reader device may be an RFID reader, for instance.

An access control manager in an object-oriented programming language such as Java takes care about whether a certain Java program or applet is allowed to access a certain piece of information of an object. Due to the fully object-oriented approach of Java, nearly everything is an object and accessing an object is one of the most frequent things a Java program does. As a consequence, the Java environment, or more precisely the access control manager, needs to do many checks whether certain accesses are to be granted/allowed or to be rejected/not allowed. In the area of Java on high performance computing platforms like PCs, this is not a real issue, but when it comes to extremely restricted platforms like Smart Cards it may be very beneficially to save time and energy of doing all these access control verifications. Hence, implementing the inventive access rights management system to trans-ponders may open transponders for completely new fields of application.

The device may be a portable device. A portable device may be a device that is configured (regarding size and weight) to be carried by a user during normal operation of the device. Such devices may require processing and memory management units requiring as less energy and/or space as possible. Examples for portable devices are a mobile phone, a headset, a headphone playback apparatus, a hearing aid, a gaming device, an audio player, a DVD player, a CD player, a hard disk-based media player, a radio device, an internet radio device, an MP3 player, a medical device, a body-worn device, or a speech communication device. The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a device for managing access rights to an object of an object oriented programming language according to an exemplary embodiment of the invention.

FIG. 2 illustrates a communication system comprising the device of FIG. 1 in combination with a reading device according to an exemplary embodiment of the invention.

FIG. 3 illustrates a flow-chart diagram illustrating a method of managing access rights to an object of an object oriented programming language according to an exemplary embodiment of the invention.

### DETAILED DESCRIPTION OF EMBODIMENTS

The illustration in the drawing is schematically. In different drawings, similar or identical elements are provided with the same reference signs.

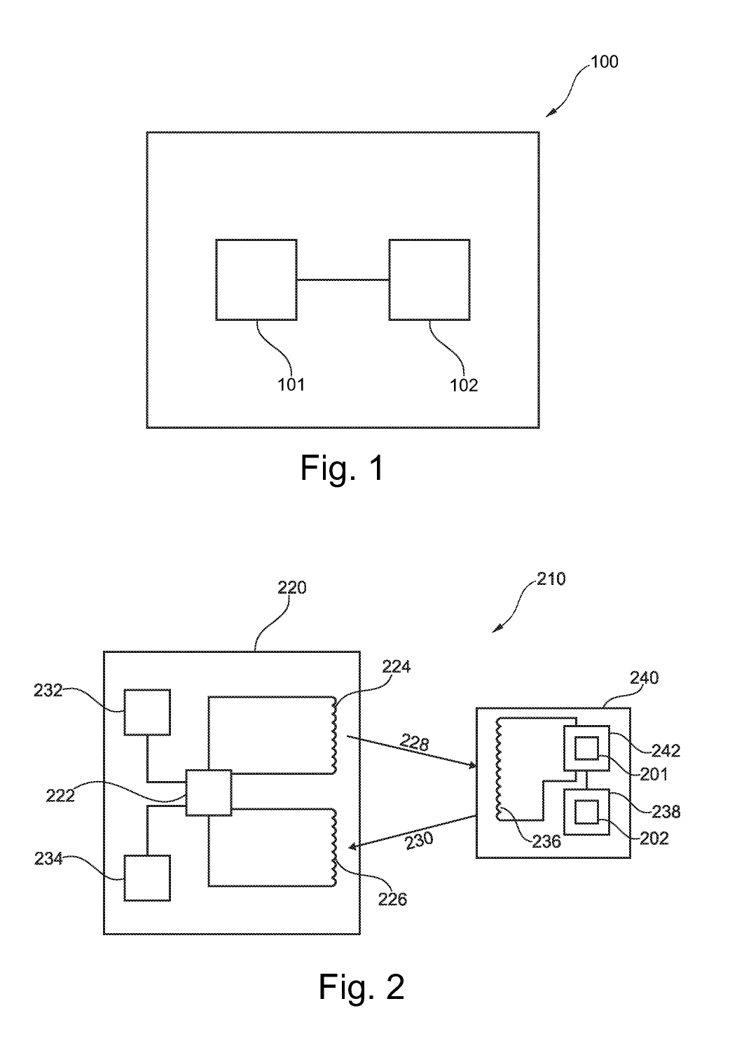

FIG. 1 illustrates a device 100 for managing access rights to an object of an object oriented programming language according to an exemplary embodiment of the invention.

The device 100 comprises a processing unit 101 and a memory management unit 102. The processing unit 101 and the memory management unit 102 are connected together for communication. They may also be provided as one single unit or may be monolithically integrated in an integrated circuit (IC). The memory management unit 102 may be a computer hardware component responsible for handling accesses to memory requested by the processing unit 101. The processing unit 101 is adapted for determining information indicative of the access rights to the object and for storing the determined information in the memory management unit 102. The processing unit 101 determines if information concerning the access rights of an object is already stored in the memory management unit 102. If the memory management unit 102 does not comprise any information concerning this object, the access rights are determined and then stored in the memory management unit 102. If access to this object is requested for the next time, the access rights do not have to be determined again but the information may be directly given by the memory management unit 102. An existing memory management unit may be used as a cache for access control decisions. The decisions are only done once and positive results are “stored” in the form of a memory management window. Following accesses to this object get speed up and reduce less power. In the following, referring to FIG. 2, a communication system 200 according to an exemplary embodiment of the invention will be explained.

The communication system 210 comprises a reader 220 and a transponder 240.

The reader 220 comprises a processor 222 (such as a microprocessor or a central processing unit) that is communicatively coupled with an emitter antenna 224 and a receiver antenna 226. The emitter antenna 224 is capable of transmitting a communication message 228 to the transponder 240. The receiver antenna 226 is capable of receiving a communication message 230 from the transponder 240. Although the transmission antenna 224 and the receiver antenna 226 are illustrated as two different antennas in FIG. 2, alternative embodiments may also use a single common shared transceiver antenna.

The antennas 224, 226 are electrically coupled with the processor 222 so that data may be sent from the processor 222 to the transmission antenna 224 for transmission as a communication message 228. A communication message 230 received by the receiver antenna 226 may also be analyzed and processed by the processor 222.

A storage unit 232 such as a semiconductor memory is coupled with the processor 222 so as to allow storing data accessible for the processor 222. Furthermore, an input/output unit 234 is shown which allows a user to operate the reader device 220. The input/output unit 234 may comprise input elements such as buttons, a keypad, a joystick or the like. Via such input elements, a user may input commands to the reader device 220. Furthermore, the input/output unit 234 may comprise a display unit such as a liquid crystal display allow displaying results of the reading procedure of the reader device 220 visible for a user.

As can be further taken from FIG. 2, the transponder 240 comprises a transmission and receiver antenna 236, a processor 242 such as a microprocessor and a memory 238. In an embodiment, the memory 238 and the processor 242 may be monolithically integrated in an integrated circuit (IC) which can be connected to the antenna 236 and attached to a support 244 such as a piece of fabric.

The communication messages 228, 230 can be exchanged in a wireless manner between the entities 220, 240.

As can be taken from FIG. 2, the communication messages 228 and 230 can be exchanged between the reader 220 and the transponder 240.

A processing unit 201 corresponding to the processing unit of FIG. 1 may be comprised in the processor 242 of FIG. 2 as shown or may be arranged separately. The same applies to a memory management unit 202 corresponding to the memory management unit of FIG. 1, which may be comprised in the memory 238 as shown or may be arranged separately. Such a communication system may be also realized with a reader and a smart card instead of the transponder communicating via a wired connection. A wired communication is for example specified by ISO 7816.

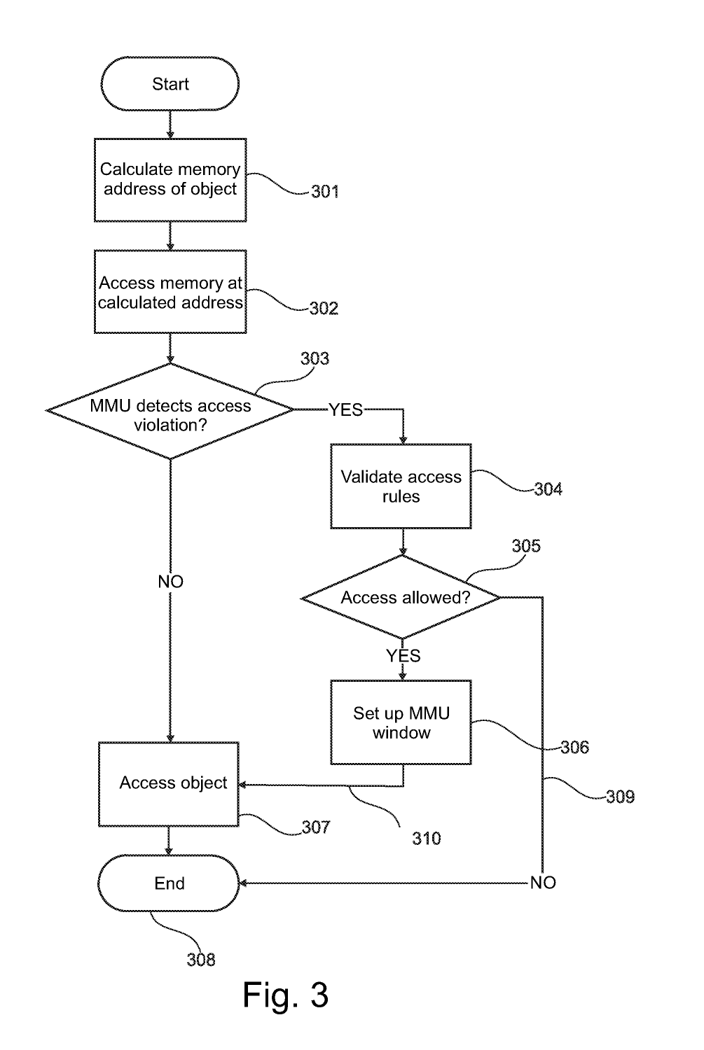

FIG. 3 illustrates a flow-chart diagram illustrating a method of managing access rights to an object of an object oriented programming language according to an exemplary embodiment of the invention.

In a first step 301, the memory address of an object is calculated to which access is requested. In this step, the general address is determined without proving access rights. In a second step 302, an access to the calculated memory is performed. In step 303, the memory management unit determines if there is an access violation or not, i.e. if an access right has already been stored or if the access is allowed.

It is assumed that the object to be accessed is an array data, which consists of five elements of type BYTE. If, when using for example Java, the Java virtual machine encounters a byte code operation to access a certain element i of this array and the memory management unit has detected an access violation, the following checks have to be performed (304 and 305 in FIG. 3).

First, the access rules are validated in step 304, i.e. which access rights or violations have to be checked. Then, it is determined in step 305 if access to the object is allowed. Therefore, it is checked if access to the array is granted in general, e.g. is the array a local variable of the code, or is it a public data member, or is it package-visible and in the same package as the current code, etc. These checks can get very expensive if the array is part of a class of a different package because in this case a lot of data needs to be parsed and evaluated before the decision can be taken. Then, in the case of an array, the index i needs to be checked. If the array consists of five elements the only valid values for i are 0<=i<=4. If either of the checks fails, the access is rejected and an exception is thrown (step 308 via connection 309). If both checks are okay, the Java virtual machine calculates the actual memory address of element i of the array and reads the corresponding BYTE from a memory.

The memory management unit is used as a cache for these checks. In step 306, if the checks in steps 304 and 305 are okay, a window in the memory management unit is set up, which allows access to the memory (step 307 via connection 310). Per default no windows are set up. This means for the first access there is an overhead to setup the MMU window. However, for every following access to this object, the memory management unit can be used to give the right decision immediately (step 303) to allow access to the object (step 307), when no access violation has been detected. This means the checks need to be done only once. Therefore there is a big potential saving in any kind of loop or repeating access of the same object.

If the program or a method of the program is completed, all windows of the memory management unit are closed. Therefore, the memory space is released for other programs or methods.

Not all of the steps of the flow-chart diagram in FIG. 3 have to be performed. The method may also be provided with only some of the steps 301 to 308.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A device for managing access rights to an object of an object oriented programming language, the device comprising:
a processing unit;
a memory management unit;
wherein the processing unit is adapted for determining information indicative of the access rights to the object and for storing the determined information in the memory management unit, wherein the memory management unit is adapted to be used as an access control decision cache.

2. The device according to claim 1, wherein the processing unit is adapted for reusing the information stored in the memory management unit.

3. The device according to claim 1, wherein the processing unit is adapted for, upon determining that information regarding an access right to the object is already stored in the memory management unit, retrieving corresponding data from the memory management unit.

4. The device according to claim 1, wherein the processing unit is adapted for determining whether a user is authorized to access the object before allowing the access to the object.

5. The device according to claim 1, wherein the object oriented programming language is Java.

6. The device according to claim 1, wherein the object is a software element.

7. The device according to claim 1, wherein the device is adapted for a wireless communication with a communication partner device, particularly a reading device, for reading data from the device.

8. The device according to claim 1, wherein the device is adapted for a wired communication with a communication partner device, particularly a reading device, for reading data from the device.

9. The device according to claim 1, wherein the device is a transponder.

10. The device according to claim 9, wherein the transponder is one of the group consisting of a smart card, a contactless chip card and an RFID tag.

11. The device according to claim 1, wherein the device is a portable device.

12. Method of managing access rights to an object of an object oriented programming language, the method comprising:
determining information indicative of the access rights to the object,
storing the determined information in a management memory unit being used as an access control decision cache.

13. A computer-readable medium, in which a computer program of managing access rights to an object of an object oriented programming language is stored, which computer program, when being executed by a processor, is adapted to carry out or control a method according to claim 12.

14. A program element of managing access rights to an object of an object oriented programming language, which program element, when being executed by a processor, is adapted to carry out or control a method according to claim 12.
